(19) United States
(12) Patent Application Publication
(10) Pub. No.: US 2010/0097589 A1
(43) Pub. Date: Apr. 22, 2010

(54) LITHOGRAPHIC APPARATUS COMPRISING AN ASSEMBLY OF A LINE CARRIER WITH LOW-FRICTION CABLES, HOSES OR THE LIKE AND SUCH AN ASSEMBLY IN GENERAL

(75) Inventors: Marcel Henri Brinkhuis, Horst (NL); Sven Pekelder, Breugel (NL)

Correspondence Address: PILLSBURY WINTHROP SHAW PITTMAN, LLP, P.O. BOX 10500, MCLEAN, VA, 22102, US

(73) Assignee: ASML Netherlands B.V., Vledhoven (NL)

(21) Appl. No.: 12/578,379

(22) Filed: Oct. 13, 2009

Related U.S. Application Data
(60) Provisional application No. 61/107,194, filed on Oct. 21, 2008.

(51) Int. Cl. G03B 27/42

(52) U.S. Cl. 355/53

(57) ABSTRACT

A lithographic apparatus includes an assembly of a plurality of flexible medium transfer lines and a line carrier, the liner carrier configured to moveably guide the plurality of flexible medium transfer lines from one connection point of the apparatus to another connection point, wherein at least one of the two connection points is movable. At least one of the flexible medium transfer lines includes an inner base layer having an outer low-friction layer provided thereon, the outer low-friction layer having lower friction capacities than the inner base layer so as to provide a smooth guiding of the at least one of the flexible medium transfer lines relative to the carrier and a neighbouring flexible medium transfer line during a movement of the at least one connection point.

### CROSS REFERENCE TO RELATED APPLICATIONS

This application claims priority and benefit under 35 U.S.C. §119(e) to U.S. Provisional Patent Application No. 61/107,194, entitled “Lithographic Apparatus Comprising An Assembly Of A Line Carrier With Low-Friction Cables, Hoses Or The Like and Such An Assembly In General”, filed on Oct. 21, 2008. The content of that application is incorporated herein in its entirety by reference.

### FIELD

The present invention relates to a lithographic apparatus including an assembly of a plurality of flexible medium transfer lines and a line carrier for moveably guiding the number of lines from one connection point of the apparatus to another, in which at least one of the two connection points is movable.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

The lithographic apparatus includes accurately movable parts such as, for example, the substrate stage and the patterning device stage. Each of these stages may be connected to a number of lines such as cables and hoses, for feeding the stage with data, electricity and other necessary media. This bundle of cables, hoses and the like is called the “aorta” and needs to be carried such that it can move relatively easily along with the stage. In order to do so, the cables may be carried by commonly available chain carriers, also known as drag chains, energy chains or cable chains. Such chain carriers include a guiding chain having a plurality of chain links articulated to one another so that they are able to flexibly curve or otherwise deform when following the movements of the stage. These chain links together partly surround and guide the number of cables, hoses and the like.

To enable a trouble free operation, the number of cables, hoses and the like in the chain links is limited. It is prescribed by manufacturers/suppliers of the presently available chain carriers that a maximum of about 80% of the available volume within the chain links may be filled with cables, hoses and the like. A higher degree of filling of the chain links will limit the freedom of movement and will lead to excessive wear of the cables, hoses and the like.

Thus, it is undesirable to arrange more hoses in the volume of a chain carrier than is prescribed. Furthermore, the available space in present lithographic apparatus is very limited, and with future developments for lithographic apparatus, the required functionality, becomes higher with every new type. For example, developments like immersion lithographic apparatus require a larger number of cables, hoses and the like. The hoses in the chain carriers need to have a large diameter to enable enough flow, but at the same time need to be very flexible to enable the hoses to be able to follow small bending radii of the carrier. One of the presently preferred options for hose material is PUR.

The increasing amount of cables, hoses and the like require them to be packed in the chain carrier closely together. In this way the cables, hoses and the like do not have enough space to move without making contact to neighboring cables hoses and the like. For example if two PUR-hoses lie next to each other within the chain carrier, a PUR-PUR contact occurs which is characterized by a high friction. This leads to stick-slip effects, causing high pulling forces on the hoses, combined with the generation of particles from their surfaces. The generation of particles has the danger of causing contamination. The high pulling forces and the wear might damage the hoses. As the hoses are used to transport fluids under pressure, this poses a risk of bursting of the hoses.

It may be possible to limit the amount of cables, hoses and the like in the chain carrier, to prevent surface contact under pressure between these cables, hoses and the like and to provide space for the cables, hoses and the like to move freely. Also internal partitions in the chain carrier can be used to prevent direct mutual surface contact. To prevent high pressure surface contact, the bending radius of the chain carrier can be enlarged, so the bending forces on the cables, hoses and the like are lessened. Another possibility is to use an extra chain carrier, for example side by side with or opposite to the already present chain carrier.

All these options however provide no solution when the available space within the apparatus is very limited.

### SUMMARY

It is desirable to provide a reliable assembly of a line carrier that includes a plurality of lines and which is both compact and flexible, while being able to include a large number of lines which are not prone to wear and which do not require high pulling forces.

According to an embodiment of the invention, there is provided a lithographic apparatus including an illumination system configured to condition a radiation beam; a support constructed to support a patterning device, the patterning device being capable of imparting the radiation beam with a pattern in its cross-section to form a patterned radiation beam; a substrate table constructed to hold a substrate; a projection system configured to project the patterned radiation beam onto a target portion of the substrate; and an assembly of a plurality of flexible medium transfer lines and a line carrier, the line carrier configured to moveably guide the plurality of lines from one connection point of the apparatus to another, wherein at least one of the two connection points is movable, wherein at least one of the lines includes an inner base layer with an outer low-friction layer provided thereon, the outer low-friction layer having friction capacities lower than the inner base layer so as to provide a smooth guiding of the line relative to at least one of its neighboring lines and carrier during a movement of the at least one connection point.

In another embodiment of the invention, there is provided an assembly of a plurality of flexible medium transfer lines and a line carrier, the line carrier configured to moveably guide the plurality of lines from one connection point of an apparatus to another, wherein at least one of the two connection points is movable, wherein at least one of the lines includes an inner base layer with an outer low-friction layer provided thereon, the outer low-friction layer having friction capacities lower than the inner base layer so as to provide a smooth guiding of the line relative to at least one of its neighboring lines and carrier during a movement of the at least one connection point.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 shows a schematic view in perspective of the substrate table of FIG. 1 with a chain carrier holding a number of transfer lines in accordance with an embodiment of the invention;

FIG. 3 shows the chain carrier of FIG. 2;

FIG. 4 shows a top view of the chain carrier of FIG. 3 without the number of cables and hoses held therein; and

FIG. 5. shows a cross section over the line V-V of FIG. 4 including the number of cables and hoses held therein.

### DETAILED DESCRIPTION

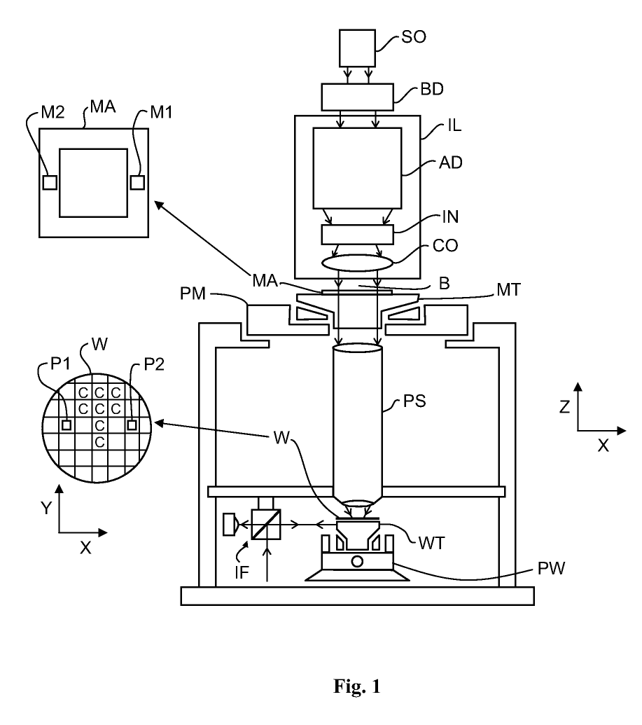

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support or a mask support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the patterning device and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as a-outer and a-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the patterning device support (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device support (e.g. mask) MA, the patterning device alignment marks may be located between the dies.

The depicted apparatus could be used in at least one of the following modes:
1. In step mode, the patterning device support (e.g. mask table) MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.
2. In scan mode, the patterning device support (e.g. mask table) MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the patterning device support (e.g. mask table) MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
3. In another mode, the patterning device support (e.g. mask table) MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

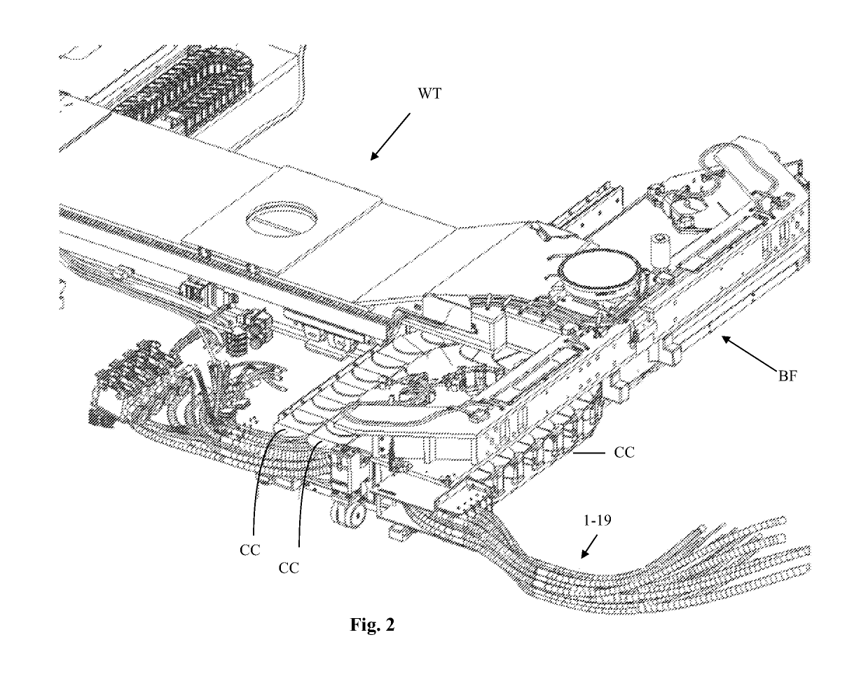

FIG. 2 shows a schematic embodiment of the substrate table WT in more detail. This substrate table WT is accurately movable with respect to the base frame BF of the apparatus by means of so called long stroke actuators and short stroke actuators. A plurality of pneumatic and/or hydraulic hoses 1-19 is connected to the substrate table WT in order to feed media like vacuum and fluids to and fro the substrate table WT. Besides these hoses 1-19 also a plurality of other lines like electricity cables, data lines and the like, also need to be connected to the substrate table WT in order to feed other media like electricity, control signals and sensor signals to and from the substrate table WT. The hoses 1-19 and the other lines are packed in chain carriers CC. Together these assemblies of chain carriers CC and lines packed therein, are called the “aorta”, which emphasizes the importance of these assemblies and their proper cooperation with their moving stage. The chain carries CC are guides which are designed to surround and guide the hoses 1-19 and other lines. They reduce the wear and stress on the lines, prevent entanglement, and improve operator safety.

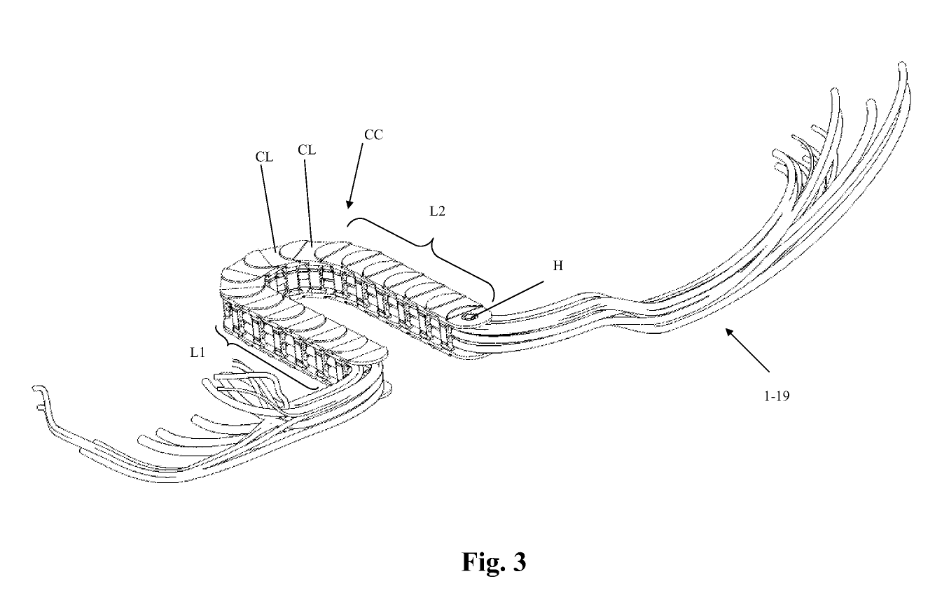

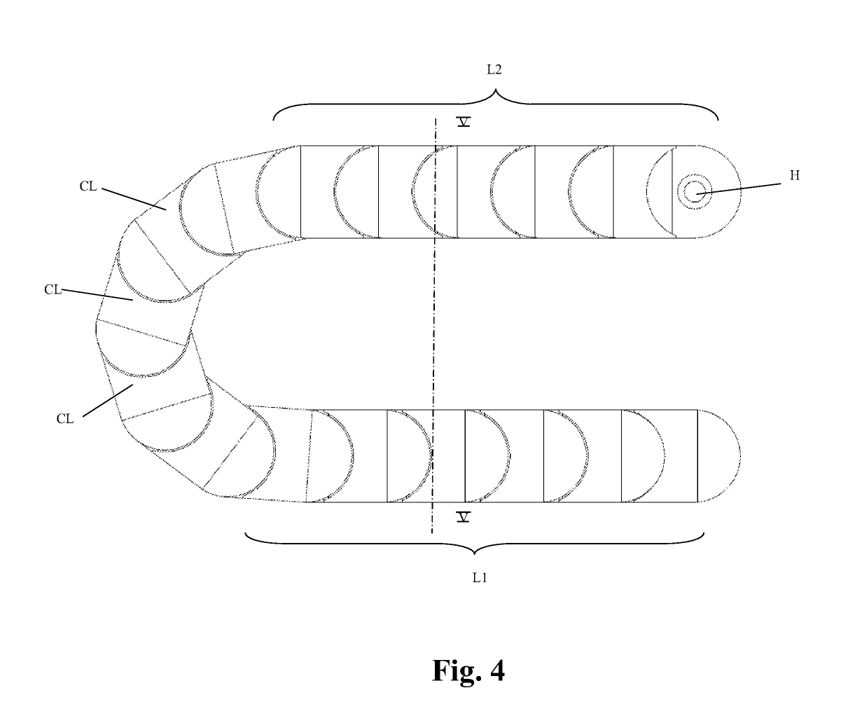

In FIG. 2, two of such chain carriers CC are provided next to one another in a nested U-shape. During movements of the substrate table WT, the one leg L1 of each U-shaped chain carrier CC is shortened whereas the other leg L2 is lengthened and vice versa, as shown in FIGS. 3 and 4. At the same time the curve connecting the legs L1, L2 rolls of Together with the changing shapes of the chain carriers CC, the hoses 1-19 and other lines packed therein are guided along with the chain carriers CC and thus also need to flexibly roll off. For this purpose the hoses 1-19 and the other lines preferably are special highly flexible hoses and lines, in order to extend their service life.

Each chain carrier CC includes a guiding chain which is built up out of a plurality of chain links CL articulated to one another by means of hinges H. Together the chain links CL surround and guide a longitudinal part of the hoses 1-19 and other lines packed therein.

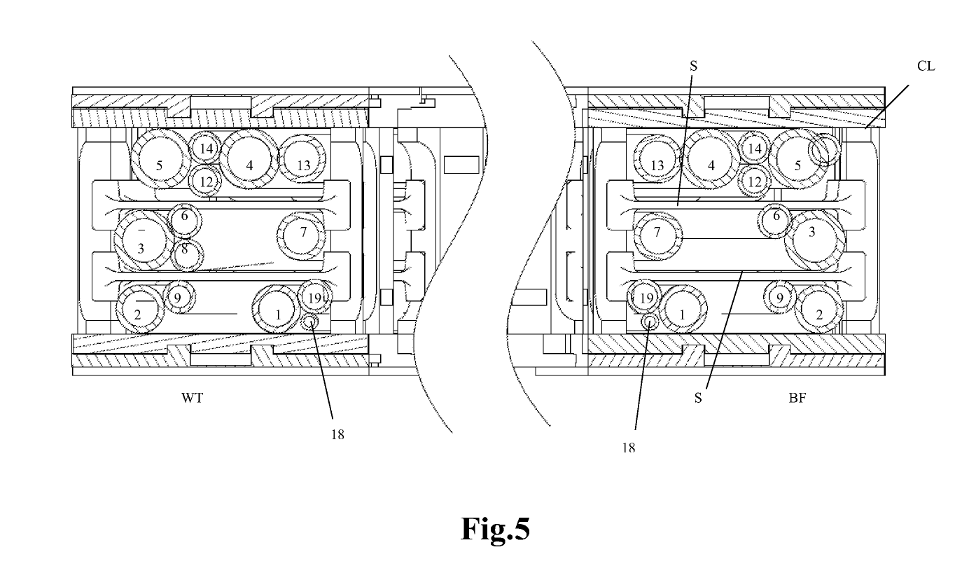

The hoses 1-19 are all packed in one and the same chain carrier CC, which is shown in more detail in FIGS. 3 and 5, whereas the other lines are all packed in the other chain carrier CC. The chain links CL of this chain carrier CC are internally divided into three segments by internal separator walls S. Within each segment a plurality of the hoses 1-19 lie closely packed next to each other in such a way that their outer surfaces are locally contacting each other.

Each of the hoses 1-19 includes a base layer. The base layer for example is made of Polyurethane (PUR) which is highly flexible and thus suitable for this use. Other materials for the base layer are also possible. The base layer may be reinforced with armoring in order to withstand high pressures. If necessary, for example because of a specific type of medium to be transported, an inner layer or coating may be provided inside the base layer.

According to an embodiment of the invention, a special outer layer is provided onto the original base layer of the hoses 1-19. This outer layer is formed by a low-friction layer which has a reduced friction coefficient compared to the friction coefficient of the original base layer. In particular, the friction coefficient of the low-friction layer may be more than twice as low as the friction coefficient of the original base layer. Thus, the hoses 1-19 are smoothly guided relative to their neighboring hoses and also relative to the inner walls and separation walls S of the chain carrier CC. When the chain carrier CC moves along with the substrate table WT and during this movement enrolls itself, then the hoses 1-19 easily slide over each others friction reducing outer layers as well as relative to the walls of the chain carrier CC itself, and are not prone to wear because of these sliding movements. The required properties of the hoses 1-19 with respect to their minimum burst pressure and flexibility are not negatively influenced by the provision of the friction reducing outer layer. For the enrolling movements of the chain carrier CC and hoses 1-19 guided therein, a relatively low pulling force is desired. All this makes the assembly of the chain carrier CC and hoses 1-19 packed therein very flexible. It is now easy for this assembly to move with its one end along with the substrate table WT while maintaining attached with its other end to the base frame BF. It is lighter to drive the actuators of the substrate table WT and the low pulling forces may even aid in further enlarging the accuracy of the driving of these actuators and thus enlarge the accuracy of the entire lithographic process. As a result, it is now possible to pack the chain carrier CC with so many hoses that its packing density becomes larger than 80%. The hoses may even be packed in such a way that they are firmly pressed to each other. This high packing density and/or packing pressure does not have a negative stick-slip-effect at the outer sides of the hoses due to their low-friction outer layers. Thus, it is possible to use less space for a larger number of hoses to be packed inside a chain carrier, and thus to smoothly go along with the recent developments in which the stages require more and more cables, hoses and the like for its increasing functionality.

In a preferred embodiment the reduced friction capacities are obtained by providing an outer layer which includes polytetrafluorethylene (PTFE) also known as Teflon™. Other friction reducing materials, may also be used as outer layer are used as an additive therein.

In a further preferred embodiment the outer low-friction layer is a surface coating which has been coated onto the base layer. Such a surface coating is already enough to obtain the desired low friction capacities and is relatively cheap to provide onto the base layer of the hose. Beneficially, the surface coating has been applied to the base layer of the hose at a temperature of above about 100 degrees Celsius, in particular at a temperature of above about 120 degrees Celsius. It has appeared that the thus attached friction reducing coating is more robust and does not peel off easy when sliding along a neighboring hose within its chain carrier CC. The coating preferably is a PTFE coating, which is applied as a shell for the current standard PUR hoses used in the “aorta” of the lithographic apparatus.

Besides the embodiment shown, numerous variant embodiments are possible. For example the friction reducing outer layer may also be provided onto one or more of the cables or the other media transfer lines of the “aortas” of the lithographic apparatus. The outer low-friction layer may be provided around substantially the entire outer circumference of the line. It is however also possible to only partly and locally provide it thereon. Also, it is not necessary to provide each of the hoses, cables and the like with the friction reducing outer layer, but to only provide the most critical ones therewith, for example the ones with the largest diameters or the ones having to withstand the highest pressures. Instead of chain carriers, other types of line carriers, like for example flexible (cable) channels, troughs or ducts may also be used in combination with one or more lines provided with a friction reducing outer layer. For example line carriers may be used which have multi-axis movement and/or which are partly open and/or which are chemical, water or temperature resistant and/or which are resistant to high loads. These line carriers are also flexible and are able to at one hand bundle the plurality of cables, hoses and the like and on the other hand guide them along with the movements of the moving part of the lithographic apparatus. The assembly of line carrier and lines packed therein is also usable for moveably guiding the lines starting from another movable connection point of the lithographic apparatus, for example the mask table or parts of the projection system. In a variant a sleeve of friction reducing material may also be used as outer low-friction layer. This sleeve for example may be made of PTFE, Nylon or the like. The sleeve may be shrunk around the base layer or may be connected thereto in another way, like only locally with its outer ends, for example by means of shrink sleeves around its outer ends.

Similar to the embodiment of FIG. 2, an assembly of chain carrier CC and lines packed therein may be connected to the patterning device support MT instead of the substrate table WT. The lines may be used to provide electrical power to actuators on the patterning device support MT. The lines may also provide a vacuum e.g. for clamping the patterning device MA onto the patterning device support MT. The lines may provide pressurized gas, for example used for a gas bearing of the patterning device support.

Embodiments of the invention may be used in an environment with an atmospheric pressure. Alternatively, embodiments of the invention may be used in an environment with a lower pressure, for example a vacuum. Reducing the friction between the lines may reduce the amount of particles that are created when lines are rubbed against each other. This may be beneficial, as the risk of particles contaminating parts of the lithographic apparatus is reduced. Particles on for example a mask, a substrate or a sensor may reduce the accuracy of the lithographic apparatus and/or may reduce the quality of a pattern projected on a target portion of the substrate. In vacuum, particles may disturb the pressure level of the vacuum. Particles floating in the path of the radiation beam B may reduce its intensity.

Embodiments of the invention are also beneficially usable outside the field of lithographic apparatus. Anywhere where there is moving automated machinery involving the transfer of energy, data, liquids and/or gases, the assembly of line carrier and one or more friction reduced lines guided therein, may be used. Examples include machine tools, medical and laboratory equipment, industrial robots, etc. For these other applications also, existing lines with the right properties like strength and flexibility, may, when provided with a friction reducing outer layer like a PTFE-surface coating onto at least some of its lines, beneficially be placed in a packing density of over 80% in a line carrier, like a commonly available chain carrier, that would normally not be able to properly accommodate and guide such a high number of lines.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

In an embodiment a lithographic apparatus includes an illumination system configured to condition a radiation beam and a support constructed to support a patterning device. The patterning device is capable of imparting the radiation beam with a pattern in its cross-section to form a patterned radiation beam. The lithographic apparatus further includes a substrate table constructed to hold a substrate, and a projection system configured to project the patterned radiation beam onto a target portion of the substrate. The lithographic apparatus also includes a plurality of flexible medium transfer lines and a line carrier. The line carrier is configured to moveably guide the plurality of flexible medium transfer lines from one connection point to another connection point of the apparatus, wherein at least one of the two connection points is movable. At least one of the flexible medium transfer lines includes an inner base layer having an outer low-friction layer provided thereon. The outer low-friction layer has friction capacities lower than the inner base layer so as to provide a smooth guiding of the least one of the flexible medium transfer lines relative to the line carrier and a neighboring flexible medium transfer line during a movement of the at least one of the two connection points.

The outer low-friction layer may include polytetrafluorethylene (PTFE). The outer low-friction layer may be a surface coating coated onto the base layer. The surface coating may be applied to the base layer at a temperature of above about 100 degrees Celsius.

At least one of the flexible medium transfer lines provided with the outer low-friction layer may be a hose. The base layer may be made of polyurethane.

At least one of the two connection points may be arranged in the substrate table.

Over 80% of a cross section of the line carrier may include flexible medium transfer lines. The line carrier may be filled with the plurality of flexible medium transfer lines firmly pressed to each other. The line carrier may include a guiding chain having a plurality of chain links articulated with one another and that at least partly surround and guide the plurality of flexible medium transfer lines.

The outer low-friction layer may be provided around substantially the entire outer circumference of the base layer of the flexible medium transfer line.

In an embodiment there is an assembly of a plurality of flexible medium transfer lines and a line carrier. The line carrier is configured to moveably guide the plurality of lines from one connection point to another connection point of an apparatus, wherein at least one of the two connection points is movable. At least one of the flexible medium transfer lines includes an inner base layer having an outer low-friction layer provided thereon. The outer low-friction layer has friction capacities lower than the inner base layer so to provide a smooth guiding of the at least one of the flexible medium transfer lines relative to the line carrier and a neighboring flexible medium transfer line during a movement of the at least one of the two connection points.

The outer low-friction layer may include polytetrafluorethylene (PTFE). The outer low-friction layer may be a surface coating coated onto the base layer. The surface coating may be applied to the base layer at a temperature of above about 100 degrees Celsius.

At least, one of the flexible medium transfer lines provided with the outer low-friction layer may be a hose. The base layer may be made of polyurethane.

Over 80% of a cross section of the line carrier may include flexible medium transfer lines.

The line carrier may be filled with the plurality of flexible medium transfer lines firmly pressed to each other. The line carrier may include a guiding chain having a plurality of chain links articulated to one another and that at least partly surround and guide the plurality of flexible medium transfer lines.

The outer low-friction layer may be provided around substantially the entire outer circumference of the base layer of the flexible medium transfer line.

What is claimed is:

1. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate;
a projection system configured to project the patterned radiation beam onto a target portion of the substrate; and
a plurality of flexible medium transfer lines and a line carrier, the line carrier configured to moveably guide the plurality of flexible medium transfer lines from one connection point to another connection point of the apparatus, wherein at least one of the two connection points is movable,
wherein at least one of the flexible medium transfer lines comprises an inner base layer having an outer low-friction layer provided thereon, the outer low-friction layer having friction capacities lower than the inner base layer so as to provide a smooth guiding of the least one of the flexible medium transfer lines relative to the line carrier and a neighboring flexible medium transfer line during a movement of the at least one of the two connection points.

2. The lithographic apparatus according to claim 1, wherein the outer low-friction layer comprises polytetrafluorethylene (PTFE).

3. The lithographic apparatus according to claim 1, wherein the outer low-friction layer is a surface coating coated onto the base layer.

4. The lithographic apparatus according to claim 3, wherein the surface coating has been applied to the base layer at a temperature of above about 100 degrees Celsius.

5. The lithographic apparatus according to claim 1, wherein the base layer is made of polyurethane.

6. The lithographic apparatus according to claim 1, wherein the at least one of the two connection points is arranged in the substrate table.

7. The lithographic apparatus according to claim 1, wherein over 80% of a cross section of the line carrier include flexible medium transfer lines.

8. The lithographic apparatus according to claim 1, wherein the line carrier is filled with the plurality of flexible medium transfer lines firmly pressed to each other.

9. The lithographic apparatus according to claim 1, wherein the line carrier comprises a guiding chain having a plurality of chain links articulated with one another and that at least partly surround and guide the plurality of flexible medium transfer lines.

10. The lithographic apparatus according to claim 1, wherein the outer low-friction layer is provided around substantially the entire outer circumference of the base layer of the flexible medium transfer line.

11. An assembly of a plurality of flexible medium transfer lines and a line carrier, the line carrier configured to moveably guide the plurality of lines from one connection point to another connection point of an apparatus, wherein at least one of the two connection points is movable,
wherein at least one of the flexible medium transfer lines comprises an inner base layer having an outer low-friction layer provided thereon, the outer low-friction layer having friction capacities lower than the inner base layer so to provide a smooth guiding of the at least one of the flexible medium transfer lines relative to the line carrier and a neighboring flexible medium transfer line during a movement of the at least one of the two connection points.

12. The assembly according to claim 11, wherein the outer low-friction layer comprises polytetrafluorethylene (PTFE).

13. The assembly according to claim 11, wherein the outer low-friction layer is a surface coating coated onto the base layer.

14. The assembly according to claim 11, wherein the surface coating has been applied to the base layer at a temperature of above about 100 degrees Celsius.

15. The assembly according to claim 11, wherein the at least one of the flexible medium transfer lines provided with the outer low-friction layer is a hose.

16. The assembly according to claim 11, wherein the base layer is made of polyurethane.

17. The assembly according to claim 11, wherein over 80% of a cross section of the line carrier include flexible medium transfer lines.

18. The assembly according to claim 11, wherein the line carrier is filled with the plurality of flexible medium transfer lines firmly pressed to each other.

19. The assembly according to claim 11, wherein the line carrier comprises a guiding chain having a plurality of chain links articulated to one another and that at least partly surround and guide the plurality of flexible medium transfer lines.

20. The assembly according to claim 11, wherein the outer low-friction layer is provided around substantially the entire outer circumference of the base layer of the flexible medium transfer line.
